(19) United States
(12) Patent Application Publication
(10) Pub. No.: US 2018/0023518 A1
(43) Pub. Date: Jan. 25, 2018

(54) FUEL GAS FUELING SYSTEM AND METHOD

(71) Applicant: Alternative Fuel Containers, LLC, Southfield, MI (US)

(72) Inventor: Joong-Kyu Lee, Chatham (CA)

(21) Appl. No.: 15/547,376

(22) PCT Filed: Feb. 12, 2016
(86) PCT No.: PCT/IB2016/050774

§ 371 Date: Jul. 28, 2017

Related U.S. Application Data
(60) Provisional application No. 62/114,115, filed on Feb. 10, 2015.

(51) Int. Cl. F02M 21/06; F02M 21/02

(52) U.S. Cl. CPC F02M 21/06; F02M 21/0206; F02M 21/0224

(57) ABSTRACT

A method and system for fueling a fuel gas storage tank carried on-board a motor vehicle is disclosed. The fueling system and method employ a fuel gas reservoir tank to supply fuel gas to the fuel gas storage tank. The fuel gas reservoir tank includes a reservoir interior that is at least five times greater in volume than a tank interior of the fuel gas storage tank. Moreover, each of the fuel gas reservoir tank and the fuel gas storage tank includes a fuel gas storage material, which is capable of solid state fuel gas storage, housed within their respective interiors. When a flow of fuel gas is circulated between the interior of the fuel gas reservoir tank and the interior of the fuel gas storage tank, fuel gas is charged into the fuel gas storage material housed within the fuel gas storage tank in a thermodynamically effective way.

This application claims the benefit of U.S. Provisional Application No. 62/114,115, filed on Feb. 10, 2015, the entire contents of which are incorporated herein by reference.

### TECHNICAL FIELD

The technical field of this disclosure relates generally to fuel gas fueling technology and, more specifically, to systems and methods for fueling a fuel gas storage tank carried on-board a motor vehicle.

### BACKGROUND

Motor vehicles are equipped with a fuel-consuming device that consumes fuel to generate the power needed to propel and operate the vehicle. Fuel gases, such as natural gas and hydrogen gas, are promising alternatives to the traditional petrol-based energy sources consumed by fuel-consuming devices. The consumption of such fuel gases (e.g., through combustion, catalyzed oxidation, etc.) generally produces less pollutants on a per unit basis than the combustion of traditional petroleum-based gasoline and diesel fuels and, thus, tends to be better for the environment. In order to hold a sufficient amount of fuel gas in an on-board storage tank at a reasonable pressure, and thus enable a driving distance comparable to traditional petroleum-based fuels, a fuel gas storage material may be contained within the storage tank to store fuel gas in a solid state. Such fuel gas storage materials can be charged with fuel gas through a variety of mechanisms (e.g., adsorption, chemical uptake, etc.) to facilitate solid state fuel gas storage.

Natural gas can be stored in a solid state by way of adsorption onto a natural gas storage material (ANG storage material). The natural gas storage material increases the volumetric and gravimetric energy density of the fuel gas within the available tank space such that it compares favorably to compressed natural gas but at a much lower pressure of 60 bar or less. Several different kinds of natural gas storage materials are known including activated carbon and, more recently, metal-organic-frameworks (MOFs) and porous polymer networks (PPNs) that have an affinity for natural gas. Many different types of MOFs and PPNs that are able to reversibly adsorb natural gas are commercially available in the marketplace and newly-identified MOFs and PPNs are constantly being researched and developed in order to enhance natural gas storage capacity as well as charging/release kinetics.

Hydrogen gas can be stored in a solid state by way of chemical uptake or adsorption onto a hydrogen storage material. The hydrogen storage material—like before with the ANG storage material—increases the volumetric and gravimetric energy density of the fuel gas within the available tank space such that it compares favorably to compressed hydrogen gas but at much lower pressure of 100 bar or less. Materials that can store hydrogen gas through chemical uptake include any of a wide range of metal hydrides and complex metal hydrides. Materials that can adsorptively store hydrogen gas include MOFs and PPNs that have an affinity for hydrogen gas. Indeed, like before with ANG storage materials, there is a wide variety of hydrogen storage materials that are commercially available in the marketplace, and many others are constantly being researched and developed in an effort to improve hydrogen gas storage capacity and charging/release kinetic behavior.

The solid state storage of natural gas and the solid state storage of hydrogen gas share similar thermodynamics. In particular, charging each of those fuel gases into an appropriate fuel gas storage material is an exothermic process while, conversely, releasing each of those fuel gases from a fuel gas storage material is an endothermic process. Thus, during driving, when fuel gas is being released from the fuel gas storage material and supplied to a fuel-consuming device, such as an internal combustion engine or a fuel cell or some other device, the ongoing endothermic process occurring within the fuel gas storage tank causes heat to be absorbed from the surrounding area. On the other hand, when fuel gas is being charged into the fuel gas storage tank for relatively high-density storage in a solid state, the ongoing exothermic charging process causes heat to be released into the surrounding area, which can slow down the net rate of fuel gas charging.

The thermodynamics of charging and releasing fuel gas from a fuel gas storage material poses some challenges when designing a refueling system that meets the certain desired fueling metrics such as fueling time, capacity, space requirements, and cost of operation. For example, when introducing a fuel gas into a fuel gas storage tank, and by extension charging it into a fuel gas storage material housed within the storage tank, the exothermic charging mechanism (e.g., adsorption, chemical uptake, etc.) releases heat which, in turn, may cause the release of fuel gas and thus reduce the net rate at which fuel gas is being charged and accumulated into the fuel gas storage material in a solid state. In other words, as fuel gas is being charged into the fuel gas storage material, the resultant heat released by the charging process causes a corresponding amount of fuel gas to be released. These competing charging/release dynamics can result in extended periods of time being needed to accumulate the desired amount of fuel gas within the fuel gas storage material during fueling.

### SUMMARY

A method and system for fueling a fuel gas storage tank is disclosed. The method and system employ a fuel gas reservoir tank to supply a flow of fuel gas to the fuel gas storage tank for charging into a fuel gas storage material housed within an interior of the fuel gas storage tank. To help with the fuel gas charging process, the fuel gas storage tank preferably includes a fuel gas transport system, comprised of one or more fuel gas permeable flow guides, which is in fluid communication with the tank interior and through which the flow of fuel gas passes. The fuel gas reservoir tank is adapted to thermodynamically assist the exothermic fuel gas charging process occurring in the fuel gas storage tank during operation of the fueling system. In particular, the fuel gas reservoir tank includes a fuel gas storage material, much like the fuel gas storage tank, and the reservoir interior of the fuel gas reservoir tank has a volume that is at least five times greater, and preferably at least ten times greater, than a volume of the fuel gas storage tank. Such features of the fuel gas reservoir tank enable it to function as a heat sink when the flow of fuel gas is circulated back to the reservoir interior after passing through the fuel gas transport system.

### BRIEF DESCRIPTION OF THE DRAWINGS

FIG. 1 is a general depiction of a fueling system that includes a fuel gas reservoir tank fluidly connected to a fuel gas storage tank carried on-board a motor vehicle;

FIG. 2 is another depiction of the fueling system shown in FIG. 1 while, here, illustrating the fuel gas reservoir tank in a cross-section;

FIG. 3 is an exemplary fueling system according to one embodiment of the disclosure;

FIG. 4 is a schematic depiction of a motor vehicle that includes the fuel gas storage tank and a fuel-consuming device with the fuel gas storage tank being connectable to the fuel gas reservoir tank as part of the fueling system shown in FIG. 3;

FIG. 5 depicts a fuel gas source that can be used to replenish the fuel gas reservoir tank with fuel gas when needed;

FIG. 6 is an exemplary fueling system according to yet another embodiment of the disclosure; and

FIG. 7 is a generalized cross-sectional view of a portion of an exemplary embodiment of a fuel gas transport system installed on the fuel gas storage tank.

### DETAILED DESCRIPTION

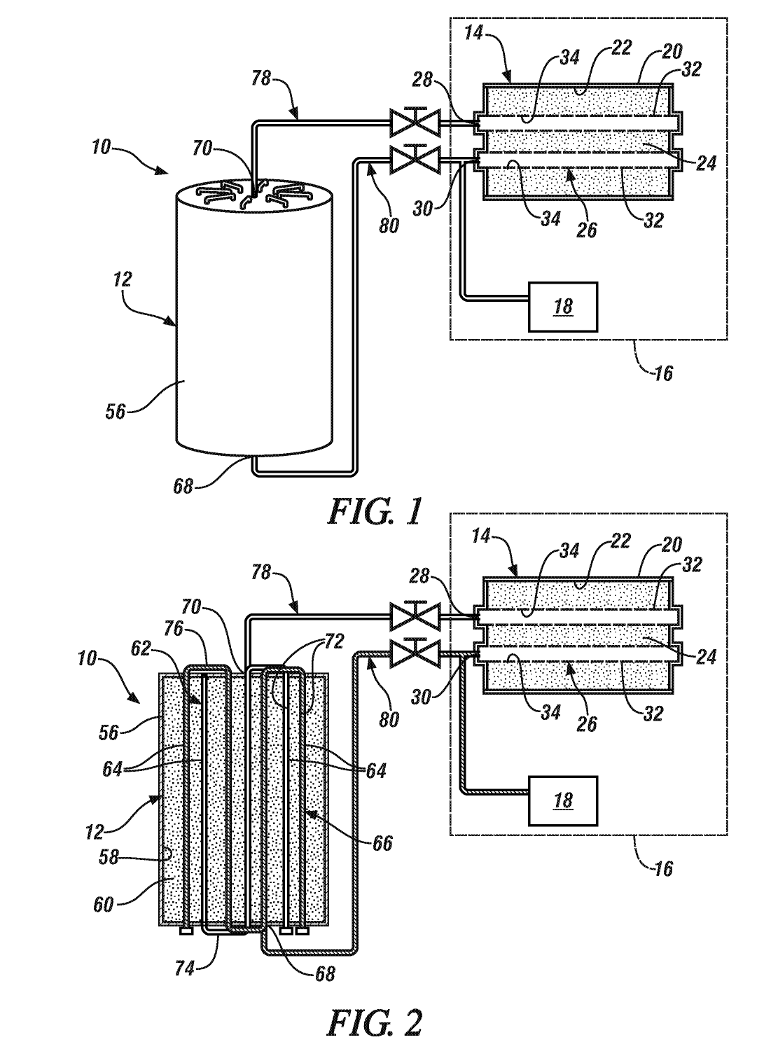

FIGS. 1-2 illustrate a general depiction of a fuel gas fueling system 10 that includes a fuel gas reservoir tank 12 connected to fuel gas storage tank 14 carried on-board a motor vehicle 16. The fuel gas storage tank 14 stores a type of fuel gas that allows a fuel-consuming device 18 to power and propel the motor vehicle 16 over a reasonable driving distance. Every so often, however, as a result of normal vehicle operation, the fuel gas storage tank 14 needs to be replenished with fuel gas. To that end, the fuel gas storage tank 14 is brought into proximity with, and fluidly connected to, the fuel gas reservoir tank 12. The resultant fuel gas fueling system 10 is then operated to deliver fuel gas to the fuel gas storage tank 14 and to ultimately increase the amount of fuel gas stored within the storage tank 14 to any desired level up to the fuel gas capacity of the storage tank 14. The fuel gas reservoir tank 12 may be constructed and installed to support a home fueling system, a drive-up retail fueling station, a mobile fueling rig, or any other commercial or residential fueling system that can be used in conjunction with the motor vehicle 16.

The fuel gas storage tank 14 is constructed to store fuel gas—such as natural gas or hydrogen gas—in a solid state. Natural gas is a fuel gas whose largest gaseous constituent is methane (CH₄). The preferred type of natural gas that is held in the fuel gas storage tank 14 is refined natural gas that includes 90 wt % or greater, and preferably 95 wt % or greater, methane. The other 5 wt % or less may include varying amounts of natural impurities—such as other higher-molecular weight alkanes, carbon dioxide, and nitrogen—and/or added impurities. Hydrogen gas is also a well known fuel gas having the chemical formula H₂. In many instances, the hydrogen gas that is stored in the fuel gas storage tank 14 has a purity of at least 99.0 wt % H₂. The fuel gas storage tank 14 is supported on a chassis of the vehicle 16 and is constructed to supply fuel gas as needed to operate the fuel-consuming device 18. The fuel-consuming device 18 may, for example, be an internal combustion engine, a fuel cell, or any other type of device that can generate power by either directly or indirectly consuming the fuel gas. For instance, the fuel gas may be consumed directly by the fuel-consuming device 18 or by an auxiliary device (e.g., a POX) that operates in conjunction with the fuel-consuming device 18.

The fuel gas storage tank 14 includes a shell 20 that defines an interior 22 of the tank 14, a fuel gas storage material 24 housed within the tank interior 22, and a fuel gas transport system 26 that fluidly communicates with a tank inlet 28 and a tank outlet 30. The shell 20 may be formed of a metal, such as stainless steel or an aluminum alloy, or a non-metallic material, such as carbon-reinforced nylon, or some other material of suitable strength and durability. A few particularly preferred materials that may be used to construct the shell 20 include SUS304 grade stainless steel or AA5083-0 aluminum alloy. The shell 20 may assume any size, shape, and contour demanded by the packing requirements of the motor vehicle 16 or other controlling factor(s). Additionally, the shell 20 may include provisions that enable it to assume shapes other than the spherical and cylindrical shapes that have traditionally been employed for the storage of fuel gasses. Indeed, the shell 20, if desired, may assume a three-dimensional shape that includes planar walls or planar wall portions as disclosed in international patent application publication nos. WO2015/065984 and WO2015/171795. The entire contents of each of those publications are incorporated herein by reference.

The fuel gas storage material 24 is contained within the tank interior 22 in the available space outside of the fuel gas transport system 26. The fuel gas storage material 24 comprises any material that is capable of reversibly storing the desired fuel gas in a solid state through any storage mechanism (e.g., adsorption, chemical uptake, etc.). Natural gas and hydrogen gas are two notable types of fuel gas that may be stored in a solid state. The fuel gas storage material 24 may, accordingly, be an ANG storage material if the fuel gas is natural gas or a hydrogen storage material if the fuel gas is hydrogen gas. An ANG storage material and a hydrogen storage material may be incorporated into the tank interior 22 in any suitable physical structure including granules, pellets, and/or powder, to name but a few options. Moreover, as previously discussed, the release of natural gas and hydrogen gas from an ANG storage material and a hydrogen storage material, respectively, when needed to operate the fuel-consuming device 18 is an endothermic process, while the charging of natural gas and hydrogen gas into the their respective fuel gas storage materials for storage in the solid state in an exothermic process.

An ANG storage material (for storing natural gas) may be an adsorbent material that stores natural gas by way of adsorption, and it preferably increases the volumetric and gravimetric energy density of the fuel gas within the tank interior 22 such that it compares favorably to compressed natural gas but at a much lower pressure of 60 bar or less. Some specific examples of materials that may constitute some or all of the ANG storage material are activated carbon, a metal-organic-framework (MOF), or a porous polymer network (PPN). Activated carbon is a carbonaceous substance, typically charcoal, that has been “activated” by known physical or chemical techniques to increase its porosity and surface area. A metal-organic-framework is a high surface area coordination polymer having an inorganic-organic framework, often a three-dimensional network, that includes metal ions (or clusters) bound by organic ligands. A porous polymer network is a covalently-bonded organic or organic-inorganic interpenetrating polymer network that, like MOFs, provides a porous and typically three-dimensional molecular structure.

Any of a wide variety of MOFs and PPNs may be used as some or all of the ANG storage material. Some notable MOFs and PPNs that may be used in the ANG storage material are disclosed in R. J. Kuppler et al., Potential applications of metal-organic frameworks, Coordination Chemistry Reviews 253 (2009) pp. 3042-66, D. Yuan et al., Highly Stable Porous Polymer Networks with Exceptionally High Gas-Uptake Capacities, Adv. Mater. 2011, vol. 23 pp. 3723-25, W. Lu et al., Porous Polymer Networks: Synthesis, Porosity, and Applications in Gas Storage/Separation, Chem. Mater. 2010, 22, 5964-72, and H. Wu et al., Metal-Organic Frameworks with Exceptionally High Methane Uptake: Where and How Methane is Stored?, Chem. Eur. J. 2010, 16, 5205-14. Of course, a wide variety of MOFs and PPNs that can adsorptively store natural gas are commercially available, and many others are constantly being researched, developed, and brought to market.

A hydrogen storage material (for storing hydrogen gas) may, in one instance, have the ability to reversibly store hydrogen gas as a hydride through chemical uptake. The hydrogen storage material—like before with the ANG storage material—preferably increases the volumetric and gravimetric energy density of the fuel gas within the tank interior 22 such that it compares favorably to compressed hydrogen gas but at a much lower pressure of 100 bar or less. Materials that can store hydrogen gas through chemical uptake include metal hydrides and complex metal hydrides. One specific example of a suitable metal hydride is lithium hydride (LH). Complex metal hydrides may include various known alanates and amides. Some specific complex metal hydrides include sodium alanate (NaAlH₄), lithium alanate (LiAlH₄), magnesium nickel hydride (Mg₂NiH₄), and lithium amide (LiNH₂). Moreover, in addition to those hydrogen storage materials that rely on chemical uptake to store hydrogen gas as a hydride, other materials exist that can adsorptively store hydrogen gas including MOFs and PPNs that have an affinity for hydrogen gas. For example, some of the MOFs and PPNs referenced in the above literature may be used for adsorptive solid state hydrogen gas storage.

The fuel gas transport system 26 includes one or more fuel gas permeable flow guide 32 that extend at least partially through the tank interior 22. The fuel gas permeable flow guide(s) 32 transport fuel gas into and out of the fuel gas storage tank 14. In particular, the fuel gas transport system 26 introduces a net amount of fuel gas into the tank interior 22, or removes a net amount of fuel gas from the tank interior 22, depending on whether fuel gas is being added to the fuel gas storage tank 14 during operation of the fueling system 10 or being supplied from the fuel gas storage tank 14 for consumption to support operation of the fuel-consuming device 18 during, for example, driving situations where the motor vehicle 16 requires power. The fuel gas permeable flow guide(s) 32 can be rendered permeable to fuel gas in any way that allows fuel gas to diffuse from inside a passageway 34 of the flow guide(s) 32, where a bulk flow of fuel gas travels along and through the guides 32, to outside of the flow guides(s) 32 and into the tank interior 22, and vice versa.

The one or more fuel gas permeable flow guides 32 can be arranged within the tank interior 22 in any way that achieves their desired function. Indeed, the pair of fuel gas permeable flow guides 32 depicted in FIG. 1 is intended to also represent multiple fuel gas permeable flow guides 32 that are disposed throughout the tank interior 22 for good exposure to all portions of the fuel gas storage material 24. The presence of multiple fuel gas permeable flow guides 32 within the tank interior 22 provides the fuel gas transport system 26 with the ability to supply fuel gas (during refueling) as evenly as possible to all portions of the fuel gas storage material 24 for charging. Likewise, during defueling, the presence of multiple fuel gas permeable flow guides 32 within the tank interior 22 provides the fuel gas transport system 26 with the ability to extract fuel gas from as much of the fuel gas storage material 24 as possible to support operation of the fuel-consuming device 18. Several examples of the fuel gas transport system 26 along with suitable constructions for the fuel gas permeable flow guides 32 are described in international patent application publication nos. WO2015/017844, WO2015/065984, and WO2015/171795. The entire contents of the WO2015/017844 publication are also incorporated herein by reference.

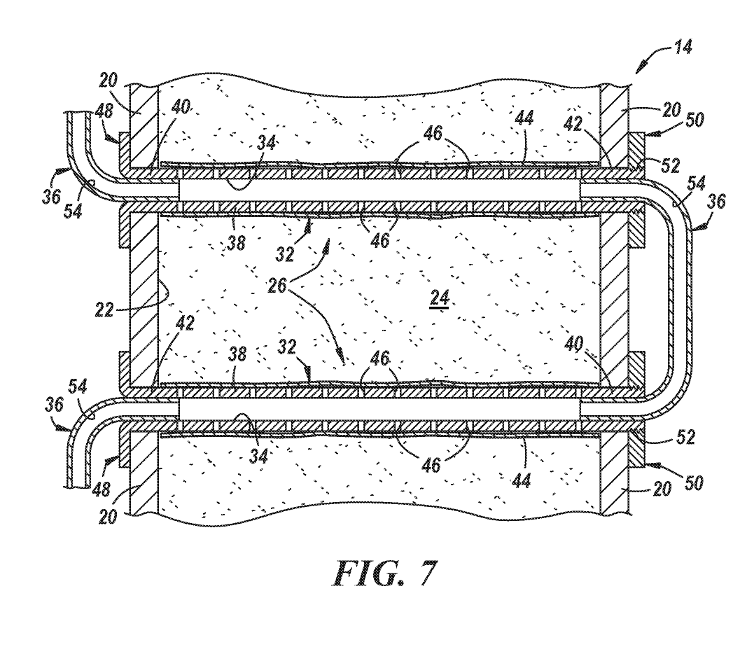

An example of a suitable fuel gas transport system 26 is shown with reference to FIGS. 1 and 7. The depicted fuel gas transport system 26 includes a plurality of the fuel gas permeable flow guides 32 and a plurality of non-permeable connector guides 36 that, as shown, extend outside of the shell 20 to fluidly connect the passageways 34 of the flow guide(s) 32 to provide a continuous fuel gas transport conduit that makes multiple runs through the tank interior 22. Specifically, during operation of the fueling system 10, the continuous fuel gas transport conduit comprised of the fuel gas permeable flow guides 32 and the non-permeable connector guides 36 directs fuel gas into the fuel gas storage tank 14 from the tank inlet 28, routes the fuel gas back-and-forth through the tank interior 22 for good exposure to all parts of the fuel gas storage material 24, and then directs fuel gas out of the tank interior 22 through the tank outlet 30 where the exiting fuel gas is eventually returned back to the fuel gas reservoir tank 12, as will be described in greater detail below.

The fuel gas permeable flow guides 32 extend through the tank interior 22 and through the fuel gas storage material 24 to a form a multi-directional array between the tank inlet 28 and the tank outlet 30. Each of the gas permeable flow guides 32 are multi-functional in that they (1) transport or convey fuel gas through the tank interior 22 via convection along a prevailing flow path established by the passageway 34 of the flow guide 32, and (2) allow for fuel gas to diffuse into and out of the flow guide 32 between the passageway 34 of the flow guide 32 and the tank interior 22. Each of the fuel gas permeable flow guides 32 also enables the transfer of heat from the tank interior 22 to the flow of fuel gas traveling through the passageway 34 of the flow guide 32 during operation of the fueling system 10. There can be any number of fuel gas permeable flow guides 32 installed in the fuel gas storage tank 14 as part of the fuel gas transport system 26 with the exact number typically depending on the shape and size of the storage tank 14.

With specific reference now to FIG. 7, each of the fuel gas permeable flow guides 32 in the fuel gas transport system 26 may include a structural wall 38 that defines the passageway 34, which extends from a first end 40 to a second end 42, and may further include a membrane 44 carried by the structural wall 38. Fuel gas can flow within and along the passageway 34 without having to directly contact the fuel gas storage material 24 contained in the tank interior 22. The structural wall 38 and the membrane 44 together allow fuel gas to diffuse from within the passageway 34 to outside of the flow guide 32 where it can be charged into the fuel gas storage material 24, and vice versa. The structural wall 38 and the membrane 44 also allow heat that is generated—for example, by the exothermic charging of fuel gas into the fuel gas storage material 24—to transfer from the tank interior 22 outside of the flow guide 32 to inside the passageway 34 where it can be captured and carried away by the fuel gas moving along and through the passageway 34. In other embodiments, the fuel gas permeable flow guide 32 may include the structural wall 38 alone if it can accommodate the cross-flow of diffused fuel gas and heat while excluding pieces of the fuel gas storage material 24 from passing through the wall 38 and entering the passageway 34.

The structural wall 38 is preferably cylindrical in shape and marked with openings 46 to facilitate the passage of fuel gas through the wall 38. The openings 46 can be regularly spaced along and around the wall 38 between the first and second ends 40, 42 of the flow guide 32, as shown. In other embodiments, the openings 46 may be defined by interrelated strands as would be found in a structural mesh, or they may be provided in any other suitable manner. In some examples, the passageway 34 can have a diameter ranging from about 3 mm to about 30 mm, the openings 46 can have a diameter ranging from about 10 μm to about 2 mm, and the structural wall 38 can have a thickness from about 1.0 mm to about 5.0 mm. Still, in other examples, the passageway 34 and the openings 46 could have diameters of different values, and the thickness of the structural wall 38 could have different values as well. For instance, if the structural wall 38 is a mesh structure, the openings 46 may be less than 50 μm in diameter, in which case the membrane 44 may not be needed as part of the flow guide 32. The structural wall 38 can be made of the same material as the shell 20, including the metal and plastic materials set forth above, or it could be composed of some other material that has suitable strength and durability.

The membrane 44 carried by the structural wall 38 provides a finer filtration medium compared to the openings 46 defined in the structural wall 38. The membrane 44 is preferably a micro- or ultra-filtration material or film that is fuel gas permeable so that fuel gas can diffuse through the membrane 44 and into or out of the passageway 34 of the flow guide 32. A network of interconnected pores preferably traverses a thickness of the membrane 44, which typically ranges from 20 μm to 2 mm. While the pores are sized to allow diffusion of the fuel gas between the passageway 34 of the flow guide 32 and the tank interior 22 where the fuel gas storage material 24 is located, their size may also be tailored to exclude particles of the fuel gas storage material 24 down to a certain size that may result from fragmentation—which can be caused over time by temperature, pressure, and load cycling—from passing through the membrane 44. In some examples, an average pore size of 10 μm to 50 μm may be suitable. The membrane 40 need not, however, necessarily prevent all traces of the fuel gas storage material 24 from entering the passageway 34, as it may be acceptable for tiny particles of the fuel gas storage material 24 to enter the passageway 34 without measurably affecting the performance of the fuel gas storage tank 14.

A number of micro- or ultra-filtration materials exist and are known in the art to be fuel gas permeable. Of these many choices, the membrane 44 may be a silica- or silicate-based desiccant material, which permits gas diffusion while, at the same time, operating to hydroscopically sorb water that may still be diffused in the fuel gas traveling through the passageway 34 of the flow guide 32. The membrane 44 can be a hydrophilic zeolite, such as ZSM-5, or an organic polymer-based membrane. The membrane 44 can be carried by the structural wall 38 of the flow guide 32 in different ways. For example, as shown here in FIG. 7, the membrane 44 is overlapped around the outside of the structural wall 38. The membrane 44 also surrounds all sides of the structural wall 38 and spans longitudinally over the extent of the wall 38 disposed within the tank interior 22. In another embodiment, the membrane 44 can be carried within the structural wall 38 on an inside surface of the wall 38 and within the passageway 34, or it may be sandwiched between the structural wall 38 and another component of the flow guide 32. The membrane 44 can be appended to the structural wall 38 by any known technique.

The fuel gas permeable flow guides 32 may be hermetically coupled at their first and second ends 40, 42 to opposed portions of the shell 20 to structurally reinforce the shell 20 and help counteract the pressures attained in the tank interior 22. In the embodiment depicted in FIG. 7, for example, each of the flow guides 32 has either a flange 48 or a threaded nut 50 at the first and second ends 40, 42 that can achieve hermetic couplings with the shell 20. The flange 48 preferably has a circular shape that extends radially outwardly from a circumference of the structural wall 38. The flange 48 can be unitary with the structural wall 38 or it can be a discrete piece attached to the wall 38 by welding, adhesion, a mechanical interlock, or some other way. The threaded nut 50 at the opposite end of the flow guide 32 has inner threads engaged with, and tightened down on, outer threads that are disposed on the exterior of the structural wall 38 to provide a threaded fastening 52. Of course, while not shown here, many other ways exists for hermetically coupling the fuel gas permeable flow guides 32 to the shell 20, as disclosed, for example, in international patent application publication nos. WO2015/017844, WO2015/065984, and WO2015/171795.

The fuel gas permeable flow guides 32 may be fluidly connected by the non-permeable connector guides 36 to establish the continuous fuel gas transport conduit that runs from the tank inlet 28 to the tank outlet 30. Each of the non-permeable connector guides 36 is routed external to the shell 20 between the second end 42 of one flow guide 32 and the first end 40 of another flow guide 32 to establish a connecting flow passage 54 between the passageways 34 of the two flow guides 32. Any type of connection may be established between the flow guides 32 and the connector guides 36 including, for example, a press-fit insertion as shown in FIG. 7. The non-permeable connector guides 36 are not permeable to fuel gas and, as such, are preferably solid pipes. The wall that makes up the solid body of the non-permeable connector guides 36 can have a thickness that ranges from 0.5 mm to 1 mm, and it can provide the connector guides 36 with a diameter to an outer surface that ranges from 3 mm and 30 mm or, more narrowly, from 5 mm to 10 mm. The non-permeable connector guides 36 can be made from the same material as the structural wall 38 of the flow guides 32 or they can be composed of a different material such as brass or some other suitable metal.

The specific embodiment of the fuel gas transport system 26 just described is merely one suitable construction that may be employed in the fuel gas storage tank 14. Other constructions are certainly possible. For example, in another embodiment, the fuel gas transport system 26 may include a first set of fuel gas permeable flow guides 32, which fluidly communicate with the tank inlet 28, and a second set of fuel gas permeable flow guides 32, which fluidly communicate with the tank outlet 30. The first and second sets of fuel gas permeable flow guides 32 are not directly connected to each other but are nonetheless able to exchange fuel gas within the tank interior 22 despite the lack of a continuous conduit. Specifically, fuel gas can diffuse between the two sets of fuel gas permeable flow guides 32 through the interstitial spaces (capillary system) of the fuel gas storage material 24 and/or through the internal pore system of the fuel gas storage material 24. The first set of fuel gas permeable flow guides 32 and/or the second set of fuel gas permeable flow guides 32 may also be coupled to opposite portions of the shell 20 to structurally reinforce the shell 20 against elevated pressures that may transpire in the tank interior 22. A more complete description of this arrangement of the one or more fuel gas permeable flow guides 32 is disclosed in international patent application publication no. WO2015/171795.

The fuel gas reservoir tank 12 includes a shell 56 that defines an interior 58 of the reservoir tank 12, a fuel gas storage material 60 housed within the reservoir interior 58, a first set 62 of one or more fuel gas permeable flow guides 64, and a second set 66 of one or more fuel gas permeable flow guides 64. The shell 56 may be constructed from any type of material, including the same materials listed above for the shell 20 of the fuel gas storage tank 14, and may be stationary or mobile depending on the construct of the fueling system 10. The reservoir interior 58 has a volume that is at least five times greater, and preferably at least ten times greater, than a volume of the tank interior 22 of the fuel gas storage tank 14. The larger volume of the reservoir interior 58 allows the fuel gas reservoir tank 12 to store a larger quantity of the fuel gas storage material 60—compared to the quantity of the fuel gas storage material 24 in the fuel gas storage tank 13—such that an adequate amount of stored fuel gas can be made available to fill the fuel gas storage tank 14. The larger volume of the reservoir interior 58 also allows the reservoir tank 12 to manage the thermodynamics of the fueling system 10 in a practical and effective way, as described below in more detail.

The first set 62 of the one or more fuel gas permeable flow guides 64 fluidly communicates with an outlet 70 of the reservoir tank 12 and the second set 66 of the one or more fuel gas permeable flow guides 64 fluidly communicates with an inlet 68 of the reservoir tank 12. The two sets 62, 66 of the one or more fuel gas permeable flow guides 64 are shown best in FIG. 2. Each of the one or more fuel gas permeable flow guides 64 in the first and second sets 62, 66 of flow guides may be constructed similarly to the fuel gas permeable flow guides 32 described above and, accordingly, are able to (1) transport or convey fuel gas through the reservoir interior 58 along a passageway 72 of the flow guide 64, (2) allow fuel gas to diffuse into and out of the flow guide 64 between the passageway 72 and the reservoir interior 58, (3) enable the transfer of heat between the reservoir interior 58 and the fuel gas traveling through the passageway 72, and (4) structurally reinforce the shell 56 of the reservoir tank 12 against the pressure attained in the reservoir interior 58 if desired.

Each set 62, 66 of the one or more fuel gas permeable flow guides 64 can include multiple fuel gas permeable flow guides 64 that extend at least partially through the reservoir interior 58 for good exposure to all portions of the fuel gas storage material 60, including those arrangements disclosed above in which the fuel gas permeable flow guides 64 extend between and are hermetically coupled to opposed portions of the shell 56. In a preferred embodiment, as shown specifically in FIG. 2, each of the first and second sets 62, 66 of the one or more fuel gas permeable flow guides 64 includes a plurality of flow guides 64, with the first and second sets 62, 66 of fuel gas permeable flow guides 64 not being directly connected to each other through a continuous conduit. In other words, fuel gas is exchanged between the first and second sets 62, 66 of fuel gas permeable flow guides 64 by diffusing through the interstitial spaces (capillary system) of the fuel gas storage material 60 and/or through the internal pore system of the fuel gas storage material 60. The flow guides 64 within the first set 62 are connected to one another by non-permeable connector guides 74 and the flow guides 64 in the second set 66 are connected to one another by non-permeable connector guides 76, as described above.

The fuel gas storage material 60 is contained within the reservoir interior 58 in the available space outside of the first and second sets 62, 66 of fuel gas permeable flow guides 64. Because the fuel gas reservoir tank 12 is designed and operable to add fuel to the fuel gas storage tank 14, the fuel gas storage material 60 housed within the reservoir interior 58 can be any material capable of reversibly storing, in a solid state, the same type of fuel gas that is stored in the fuel gas storage tank 14. The fuel gas storage material 60 may, accordingly, be an ANG storage material if the fuel gas being stored in a solid state is natural gas or a hydrogen storage material if the fuel gas being stored in a solid state is hydrogen gas. Any of the ANG storage materials (if the fuel gas is natural gas) or the hydrogen storage materials (if the fuel gas is hydrogen gas) discussed above may be used as all or part of the fuel gas storage material 60. Such fuel gas storage materials may be incorporated into the fuel gas reservoir tank 12 in any suitable physical structure including granules, pellets, and/or powder, to name but a few options.

The fuel gas reservoir tank 12 is connectable to the fuel gas storage tank 14 so that a flow of fuel gas can be circulated to the storage tank 14 and back during fueling of the tank 14. As shown in FIGS. 1 and 2, when the fuel gas reservoir tank 12 and the fuel gas storage tank 14 are connected, a feed line 78 fluidly connects the reservoir outlet 70 with the tank inlet 28, and a return line 80 fluidly connects the reservoir inlet 68 with the tank outlet 30. Parts of the feed line 78 and the return line 80 are physically carried by, and attached to, the fuel gas reservoir tank 12 and other complimentary parts are physically carried by, and attached to, the fuel gas storage tank 14. The separate parts that are brought together to constitute the two lines 78, 80 can be operably fluidly connected to complete the circuit through accessible connection features of a conventional nature when the fuel gas storage tank 14 of the motor vehicle 16 is brought into proximity with the fuel gas reservoir tank 12 for fueling. The portions of the feed line 78 and the return line 80 where connections are established between the fuel gas reservoir tank 12 and the fuel gas storage tank 14 may be rigid or flexible depending on various factors and design considerations.

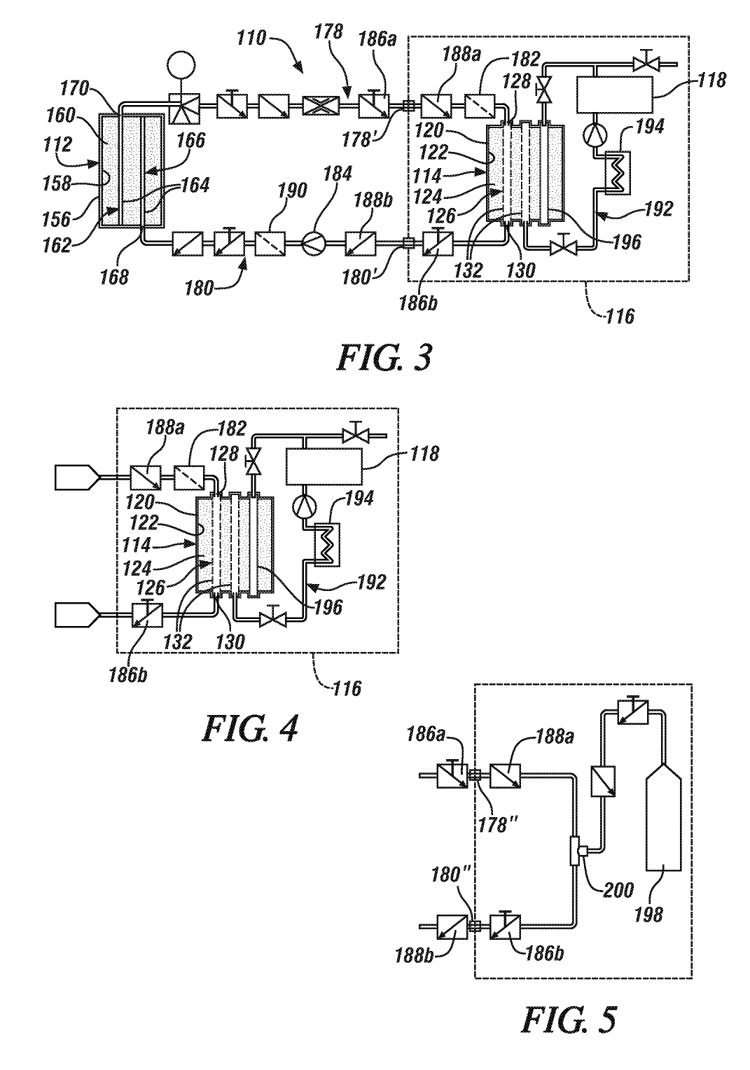

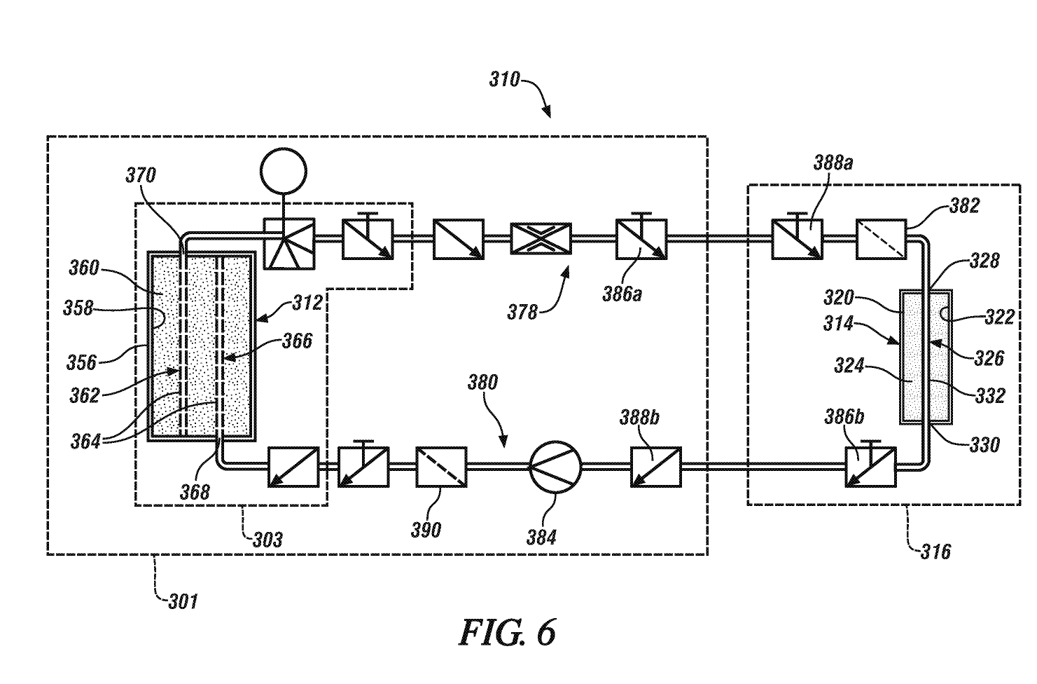

When the fuel gas storage tank 14 is connected to the fuel gas reservoir tank 12 through the feed line 78 and the return line 80, the fueling system 10 can be operated to fill the fuel gas storage tank 14, which basically entails increasing, over time, the amount of fuel gas stored in a solid state in the fuel gas storage material 24 contained in the fuel gas storage tank 14. The fueling process involves first releasing fuel gas from the fuel gas storage material 60 contained within the reservoir interior 58 of the reservoir tank 12. A flow of fuel gas is collected by the first set 62 of fuel gas permeable flow guide(s) 64 and carried to the reservoir outlet 70. The flow of fuel gas then exits the reservoir interior 58 of the reservoir tank 12 at the reservoir outlet 70 and travels through the feed line 78. The delivery of the flow of fuel gas through the feed line 78 may be commenced and sustained by maintaining the reservoir interior 58 at a higher pressure than that of the tank interior 22—preferably at least 10% higher—and by also optionally incorporating a pump (not shown in FIGS. 1-2) in the feed line 78, the return line 80, or both the feed line 78 and the return line 80. The pump is operated to circulate or help circulate the flow of fuel gas between the fuel gas reservoir 12 and the fuel gas storage tank 14 through the feed and return lines 78, 80. In a preferred embodiment, the pump is included in the return line 80, as shown, for example, in the embodiments depicted in FIGS. 3 and 6.

The flow of fuel gas moving through the feed line 78 eventually enters the fuel gas storage tank 14 at the tank inlet 28 and travels through the fuel gas transport system 26 including the one or more fuel gas permeable flow guides 32 that are disposed within the tank interior 22 and extend through the fuel gas storage material 24. As the flow of fuel gas moves through the fuel gas transport system 26, a portion of the flow of fuel gas diffuses through the fuel gas permeable flow guide(s) 32 and into the tank interior 22 where it makes contact with and is charged into the fuel gas storage material 24 that surrounds the flow guide(s) 32. Moreover, at the same time fuel gas is diffusing out of the fuel gas permeable flow guide(s) 32, heat that is generated from the exothermic fuel gas charging process is transferred from the tank interior 22 into the flow guide(s) 32 where it is absorbed by the flow of fuel gas moving through the passageway 34 of the flow guide(s) 32. After passing through the fuel gas transport system 26, the flow of fuel gas—minus the portion that diffused into the tank interior 22 and plus the absorbed heat from fuel gas charging—exits the fuel gas storage tank 14 at the tank outlet 30 and enters the return line 80.

The flow of fuel gas moving through the return line 80 is delivered back to the fuel gas reservoir tank 12 and, in particular, to the second set 66 of fuel gas permeable flow guide(s) 64 through the reservoir inlet 68. Once in the second set 66 of the fuel gas permeable flow guide(s) 64, the fuel gas diffuses, with the help of back pressure from the incoming flow of fuel gas, into the reservoir interior 58 where it makes contact with the fuel gas storage material 60. Fuel gas is thus simultaneously being extracted from the fuel gas storage material 60 by the first set 62 of fuel gas permeable flow guide(s) 64 and delivered to the fuel gas storage material 60 by the second set 66 of fuel gas permeable flow guide(s) 64. This circulating flow of fuel gas from the reservoir interior 58, through the fuel gas transport system 26 of the fuel gas storage tank 14, and back to the reservoir interior 58 functions to charge fuel gas into the fuel gas storage material 24 of the fuel gas storage tank 14 at a satisfactory rate due to the fact that heat from the exothermic fuel gas charging process is being continuously removed from the tank interior 22 and brought back to the reservoir interior 58.

The return of thermal energy to the reservoir interior 58 by way of the flow of fuel gas in the return line 80 is manageable over the course of fueling since the volume of the reservoir interior 58 is at least five times greater than the volume of the tank interior 22 of the fuel gas storage tank 14. The larger volume of the reservoir interior 58 allows the reservoir tank 12 to function as a heat sink for the rejection of heat that has been acquired by the circulating flow of fuel gas as it passes through the fuel gas transport system 26. In particular, the heat gained by the flow of fuel gas as it passes through the fuel gas transport system 26 as result of the exothermic fuel gas charging process can be consumed by the endothermic fuel gas release process simultaneity occurring in the reservoir interior 58 while also being dispersed amongst an appreciably larger volume of the fuel gas storage material 60. These exothermic fuel gas charging and endothermic fuel gas release processes occurring in the fuel gas storage tank 14 and the fuel gas reservoir tank 12, respectively, counterbalance one another and help guard against a substantial decrease in the rate of fuel gas charging into the fuel gas storage material 24.

The reliability of the heat sink capacity of the fuel gas reservoir tank 12 makes the design of the fueling system 10 more robust and flexible. Because the exothermic fuel gas charging process (occurring in the tank interior 22) is canceled out by endothermic fuel gas release process (occurring in the reservoir interior 58), thus resulting in little or no net accumulation of heat within the fueling system 10, the flow of fuel gas can be continuously supplied through the fuel gas transport system 26 for the time needed to charge the fuel gas storage material 24 and fill the fuel gas storage tank 14 to its desired capacity without the need to operate a heat exchanger in order to remove heat from the fueling system 10. In this way, the fueling system 10 is rendered simple and practical, since the successful operation of the system 10 does not depend on necessarily having to integrate a heat exchanger into the overall system architecture, thus minimizing the mechanical and operational complexity of the system 10.

One specific example of the fueling system described above is illustrated in FIG. 3 and identified by reference numeral 110. In this embodiment, like numbers are used to indicate that the description in the earlier embodiment of FIGS. 1-2 is also applicable to this embodiment and, as such, only notable differences will be further described below. Here, in FIG. 3, dotted line 116 represents the motor vehicle, which includes the fuel gas storage tank 114 and the fuel-consuming device 118 that operates through direct or indirect consumption fuel gas from the fuel gas storage tank 114. The vehicle 116 also includes a filter 182, for example a coalescing filter, for disposition in the feed line 178 to remove contaminants such as humidity and/or oils from the flow of fuel gas before the fuel gas enters the inlet 128 of storage tank 114. The portions of the feed line 178 and the return line 180 carried by the fuel gas storage tank 114 and the fuel gas reservoir tank 112 are brought together and fluidly connected at connection joints 178′, 180′.

When the vehicle 116 is located proximate the fuel gas reservoir tank 112 and fueling of the fuel gas storage tank 114 is desired, the fuel gas storage tank 114 can be connected to the fuel gas reservoir tank 112 with the connection joints 178′, 180′ in each of the feed line 178 and the return line 180 being made between an upstream stop check valve 186a, 186b and a downstream check valve 188a, 188b. The upstream stop check valves 186a, 186b and the downstream check valves 188a, 188b prevent fuel gas from escaping to the atmosphere when the fuel gas reservoir tank 112 and the fuel gas storage tank 114 are unconnected, but can otherwise be controlled or actuated to permit the flow of fuel gas through the feed line 178 and the return line 180 when the connection joints 178′, 180′ are established. The return line 180 additionally includes a pump 184 to help drive the flow of fuel gas through the fueling system 110 and a filter 190 (e.g., a coalescing filter) to remove contaminants and keep them from entering the fuel gas reservoir tank 112.

The fuel gas storage tank 114 can be filled with fuel gas, which is stored in a solid state in a fuel gas storage material 124 housed within a tank interior 122, as described above when connected to the fuel gas reservoir tank 112. After fueling, the fuel as storage tank 114 is disconnected from the fuel gas reservoir tank 112 by disengaging the connection joints 178′, 180′. The motor vehicle 116 is then operated by consuming fuel gas supplied by the fuel gas storage tank 114 to support the fuel-consuming device 118. Indeed, as illustrated here (and in FIG. 4), a cooling circuit 192 may be routed from the fuel gas storage tank 114 to a passenger compartment 194 to help cool the passenger compartment 194 of the motor vehicle 116 when fuel gas is being directly or indirectly consumed by the fuel-consuming device 118, as described in international patent application no. PCT/US2016/015349, the entire contents of which are incorporated herein by reference. The fuel gas storage tank 114 may also include one or more solid exhaust gas flow guides 196 that are configured to route hot exhaust gas expelled from the fuel-consuming device 118 throughout the tank interior 122 to increase the rate of fuel gas release from the fuel gas storage material 124 when needed to support operation of the fuel-consuming device 118.

The fuel gas reservoir tank 112 can fill the fuel gas storage tank 114 with the desired amount of fuel gas numerous times, whenever needed, as operation of the motor vehicle 116 depletes the amount of fuel gas stored in the fuel gas storage tank 114. At some point, however, after multiple events of refueling the fuel gas storage tank 114, the fuel gas reservoir tank 112 may itself need to be replenished with fuel gas. In such a scenario, the motor vehicle 116 (shown alone in FIG. 4) is first detached from the fuel gas reservoir tank 112 at the connection joints 178′, 180′ in the feed line 178 and the return line 180 between the upstream stop check valves 186a, 186b and the downstream check valves 188a, 188b. Then, a fuel gas source 198, depicted in FIG. 5, can be connected to the fuel gas reservoir tank 112 to establish fluid connection joints 178″, 180″ of the same basic function. The fuel gas source 198 employed here may be any suitable type including a residential fuel gas supply, a mobile commercial fuel gas supply, or any other type of fuel gas supply.

When the fuel gas source 198 is connected to the fuel gas reservoir tank 112, fuel gas is delivered through a t-junction 200 or other suitable mechanism and down both the feed line 178 and the return line 180 in the same direction to deliver a flow of fuel gas to both the first and second sets 162, 166 of fuel gas permeable flow guides 164 that are disposed within the reservoir interior 158 and extend through the fuel gas storage material 160. The delivered fuel gas diffuses out of the first and second sets 162, 166 of fuel gas permeable flow guides 164 and into the reservoir interior 158. The diffused fuel gas is charged into the fuel gas storage material 160 in a solid state. And, while not expressly illustrated here, the fuel gas source 198 and or the fuel gas reservoir tank 112, or both, may be outfitted with a closed loop cooling circuit such as, for example, the one shown in international patent application publication no. WO2015/065996, to help speed up the refueling process by removing heat from the reservoir interior 158 that is generated during the exothermic fuel gas charging process.

Another specific example of the fueling system described above is illustrated in FIG. 6 and identified by reference numeral 310. In this embodiment, like numbers are used to indicate that the description in the earlier embodiments of FIGS. 1-2 and 3-4 is also applicable to this embodiment and, as such, only notable differences will be further described below. Here, in FIG. 6, dotted line 316 represents the motor vehicle, which includes the fuel gas storage tank 314 and the fuel-consuming device (not shown) that receives fuel gas from the fuel gas storage tank 314. Dotted line 301 represents a refueling station (home, retail, mobile, etc.) or a refueling rig and dotted line 303 within the refueling station/refueling rig 301 represents a separable unit that includes the fuel gas reservoir tank 312. The refueling system 310 depicted here is similar in structure and operation to the refueling system 110 shown in FIG. 3 and is thus labeled in a corresponding way. In particular, the fuel gas storage tank 314 of the vehicle 316 is similarly connectable to the fuel gas reservoir tank 312 and, once connected, can be refueled in similar fashion. The fuel gas reservoir tank 312 can also be replenished with fuel gas as previously described with respect to the refueling system 110 depicted in FIG. 3.

The above description of preferred exemplary embodiments and related examples are merely descriptive in nature; they are not intended to limit the scope of the invention as defined by the claims that follow. Each of the terms used in the appended claims should be given its ordinary and customary meaning as understood by a person of skill in the art unless specifically and unambiguously stated otherwise in the specification.

1. A method of fueling a fuel gas storage tank carried on-board a motor vehicle, the method comprising:
connecting a fuel gas storage tank carried on-board a motor vehicle to a fuel gas reservoir tank, the fuel gas storage tank having a tank interior and the fuel gas reservoir tank having a reservoir interior, the reservoir interior being at least five times greater in volume than the tank interior, and wherein the fuel gas storage tank comprises a fuel gas storage material housed within the tank interior that can store fuel gas in a solid state, and wherein the fuel gas reservoir tank comprises a fuel gas storage material housed within the reservoir interior that includes fuel gas stored in a solid state;
removing a flow of fuel gas from the reservoir interior of the fuel gas reservoir tank;
passing the flow of fuel gas from the reservoir interior through a fuel gas transport system that fluidly communicates with the tank interior of the fuel gas storage tank, the flow of fuel gas passing through the fuel gas transport system from an inlet of the fuel gas storage tank to an outlet of the fuel gas storage tank such that some of the flow of fuel gas diffuses into the tank interior of the fuel gas storage tank for charging into the fuel gas storage material housed therein; and
returning the flow of fuel gas from the outlet of the fuel gas storage tank back into the reservoir interior of the fuel gas reservoir tank.

2. The method set forth in claim 1, wherein the fuel gas is natural gas, and wherein the fuel gas storage material housed within each of the tank interior of the fuel gas storage tank and the reservoir interior of the fuel gas reservoir tank is a natural gas storage material that stores natural gas through adsorption.

3. The method set forth in claim 2, wherein the natural gas storage material housed within each of the tank interior of the fuel gas storage tank and the reservoir interior of the fuel gas reservoir tank comprises at least one of activated carbon, a metal-organic-framework, or a porous polymer network.

4. The method set forth in claim 1, wherein the fuel gas is hydrogen gas, and wherein the fuel gas storage material housed within each of the tank interior of the fuel gas storage tank and the reservoir interior of the fuel gas reservoir tank is a hydrogen storage material that stores hydrogen gas through chemical uptake or adsorption, and wherein the hydrogen storage material housed within each of the tank interior of the fuel gas storage tank and the reservoir interior of the fuel gas reservoir tank comprises at least one of a metal hydride, a complex metal hydride, a metal-organic-framework, or a porous polymer network.

5. (canceled)

6. The method set forth in claim 1, wherein the reservoir interior of the fuel gas reservoir tank is at least ten times greater in volume than the tank interior of the fuel gas storage tank.

7. The method set forth in claim 1, wherein a pressure of the reservoir interior of the fuel gas reservoir tank is at least 10% greater than a pressure of the tank interior of the fuel gas storage tank during passing of the flow of fuel gas through the fuel gas transport system.

8. (canceled)

9. The method set forth in claim 1, wherein a feed line fluidly connects a reservoir outlet of the fuel gas reservoir tank and the inlet of the fuel gas storage tank, and wherein a return line fluidly connects the outlet of the fuel gas storage tank and an inlet of the fuel gas reservoir tank.

10. The method set forth in claim 9, wherein the fuel gas reservoir tank includes a first set of fuel gas permeable flow guides and a second set of fuel gas permeable flow guides, the first set of fuel gas permeable flow guides being fluidly connected to the reservoir outlet through which the flow of fuel gas is removed from the reservoir interior, the second set of fuel gas permeable flow guides being fluidly connected to the reservoir inlet through which the flow of fuel gas is returned to the reservoir interior, and wherein the fuel gas permeable flow guides of each of the first and second sets are disposed within the reservoir interior and extend through the fuel gas storage material housed within the reservoir interior.

11. The method set forth in claim 10, wherein the first set of fuel gas permeable flow guides and the second set of fuel gas permeable flow guides are not directly connected to each other.

12. The method set forth in claim 9, further comprising operating a pump located in at least one of the feed line or the return line to circulate the flow of fuel gas from the reservoir interior, through the fuel gas transport system, and back to the reservoir interior.

13. The method set forth in claim 1, further comprising:
disconnecting the fuel gas storage tank from the fuel gas reservoir tank after increasing an amount of fuel gas stored in a solid state in the fuel gas storage material housed within the tank interior.

14. The method set forth in claim 13, further comprising
connecting the fuel gas reservoir tank to a source of fuel gas; and
supplying fuel gas from the source of fuel gas to the reservoir interior of the fuel gas reservoir tank to increase an amount of fuel gas stored in a solid state in the fuel gas storage material housed within the reservoir interior.

15. A method of fueling a fuel gas storage tank carried on-board a motor vehicle, the method comprising:
removing a flow of fuel gas from a reservoir interior of a fuel gas reservoir tank that houses a fuel gas storage material in which fuel gas is stored in a solid state, and wherein fuel gas is endothermically released from the fuel gas storage material housed within the reservoir interior during removal of the flow of fuel gas from the reservoir interior; and
circulating the flow of fuel gas through a fuel gas transport system in fluid communication with a tank interior of a fuel gas storage tank connected to the fuel gas reservoir tank and then back to the interior of the fuel gas reservoir tank, at least some of the flow of fuel gas being exothermically charged for storage in a solid state into a fuel gas storage material housed within the tank interior as the flow of fuel gas is passing through the fuel gas transport system, and wherein the reservoir interior of the fuel gas reservoir tank has a volume that is at least five times greater than a volume of the tank interior of the fuel gas storage tank.

16. The method set forth in claim 15, wherein the fuel gas transport system fluidly communicates with an inlet of the fuel gas storage tank and an outlet of the fuel gas storage tank and further includes one or more fuel gas permeable flow guides disposed within the tank interior and extending through the fuel gas storage material housed within the tank interior.

17. The method set forth in claim 16, wherein a feed line fluidly connects a reservoir outlet of the fuel gas reservoir tank and the inlet of the fuel gas storage tank, and wherein a return line fluidly connects the outlet of the fuel gas storage tank and a reservoir inlet of the fuel gas reservoir tank.

18. The method set forth in claim 17, wherein the fuel gas reservoir includes a first set of fuel gas permeable flow guides and a second set of fuel gas permeable flow guides, the first set of fuel gas permeable flow guides being fluidly connected to the reservoir outlet, the second set of fuel gas permeable flow guides being fluidly connected to the reservoir inlet, and wherein the fuel gas permeable flow guides of each of the first and second sets are disposed within the reservoir interior and extend through the fuel gas storage material housed within the reservoir interior.

19. The method set forth in claim 18, wherein the first set of fuel gas permeable flow guides and the second set of fuel gas permeable flow guides are not directly connected to each other.

20.-21. (canceled)

22. The method set forth in claim 15, wherein the volume of the reservoir interior of the fuel gas reservoir tank is at least ten times greater than the volume of the tank interior of the fuel gas storage tank, and wherein a pressure of the reservoir interior of the fuel gas reservoir tank is at least 10% greater than a pressure of the tank interior of the fuel gas storage tank during passing of the flow of fuel gas through the fuel gas transport system.

23. (canceled)

24. The method set forth in claim 15, further comprising
connecting the fuel gas reservoir tank to a source of fuel gas when the fuel gas reservoir tank is not connected to a fuel gas storage tank; and
supplying fuel gas from the source of fuel gas to the reservoir interior of the fuel gas reservoir tank to increase an amount of fuel gas stored in a solid state in the fuel gas storage material housed within the reservoir interior.

25. A fueling system for fueling a fuel gas storage tank carried on-board a motor vehicle, the fueling system comprising:
a fuel gas reservoir tank having a fuel gas storage material housed within a reservoir interior of the fuel gas reservoir tank, the fuel gas storage material housed within the reservoir interior being able to store fuel gas in a solid state;
a fuel gas storage tank having a fuel gas storage material housed within a tank interior of the fuel gas storage tank, the fuel gas storage material housed within the tank interior being able to store fuel gas in a solid state, and wherein a volume of the reservoir interior of the fuel gas reservoir tank is at least five times greater than a volume of the tank interior of the fuel gas storage tank;
a feed line that fluidly connects a reservoir outlet of the fuel gas reservoir tank and an inlet of the fuel gas storage tank; and
a return line that fluidly connects an outlet of the fuel gas storage tank and a reservoir inlet of the fuel gas reservoir tank;
wherein the fuel gas reservoir tank includes a first set of fuel gas permeable flow guides and a second set of fuel gas permeable flow guides, the first set of fuel gas permeable flow guides being fluidly connected to the reservoir outlet, the second set of fuel gas permeable flow guides being fluidly connected to the reservoir inlet, and wherein the fuel gas permeable flow guides of each of the first and second sets are disposed within the reservoir interior and extend through the fuel gas storage material housed within the reservoir interior

26.-33. (canceled)
